(19) United States
(12) Patent Application Publication
(10) Pub. No.: US 2003/0224503 A1
(43) Pub. Date: Dec. 4, 2003

(54) In-situ microorganism generation for treating subsurface DNAPL source zones

(76) Inventor: David S. Lipson, Arvada, CO (US)

Correspondence Address: MICHAEL P. WILLIAMS, BOND, SCHOENECK & KING, PLLC, ONE LINCOLN CENTER, SYRACUSE, NY, 13202, US

(21) Appl. No.: 10/162,291

(22) Filed: Jun. 4, 2002

(51) Int. Cl. C12S 13/00

(52) U.S. Cl. 435/262.5

(57) ABSTRACT

A method of in-situ bioremediation for treating underground nonaqueous phase liquid contamination. This includes providing a delivery means for supply acetic acid to a DNAPL target zone. The next step includes supplying the acetic acid by the delivery means so that the acetic acid is introduced into the DNAPL target zone. This allows the natural microorganisms in the DNAPL target zone to metabolize the acetic acid thereby creating anaerobic conditions and destroying DNAPL chemicals. The final step includes maintaining the anaerobic conditions for a sufficient period of time such that the microorganisms are enhanced and produced until remediation is complete.

### FIELD OF THE INVENTION

This invention relates to a method of in-situ bioremediation for treating underground nonaqueous liquid contamination, and more particularly to a method of in situ microorganism generation using acetic acid.

### BACKGROUND OF THE INVENTION

The contamination of groundwater with potentially hazardous materials is a common problem facing industry, the government and the general public. Frequently, as a result of spills, leakage from storage facilities or surface discharges the contaminants percolate into the groundwater thereby posing a threat to human health and the environment. Once polluted, restoring the affected groundwater to pristine or background conditions is difficult and long term. Furthermore, it may be technically impracticable to restore groundwater contaminated with dense nonaqueous phase liquid (DNAPL) in some cases. The various methods for withdrawing and treating the contaminated groundwater have met with limited success. The groundwater is removed from the contaminated area, treated, and then returned to the contaminated area. These methods involve great expense and incur risks inherent in treating contaminants.

Most organic compounds have a limited solubility in water. Due to their low solubilities, when released in the subsurface they often do not dissolve totally in groundwater. The organic compounds remain as a separate organic-liquid which is a nonaqueous phase liquid (NAPL). Those NAPLs that are more dense than water, for example, DNAPLs, tend to sink beneath the water table. The remediation of dense nonaqueous phase liquid (DNAPL) contaminated sites are particularly difficult because the DNAPLs tend to sink beneath the water table. Consequently, this poses a serious challenge to all conventional groundwater remediation technologies.

Chlorinated solvents, singularly or in mixtures, comprise one of the most common types of DNAPL encountered at contaminated properties. They are also among the most common groundwater pollutants regulated by federal and state agencies. Promulgated maximum contaminant levels (MCLs) for chlorinated compounds are in the order of a few parts per billion in groundwater. Chlorinated solvents include the common contaminants tetrachloroethylene (PCE), trichloroethylene (TCE), isomers of 1-2 Dichloroethylene (DCE), vinyl chloride (VC) and isomers of trichloroethane (TCA). Other common DNAPLs encountered at contaminated properties include polycyclic aromatic hydrocarbons (PAHs), polychlorinated biphenyls (PCBs), coal tar and creosote. DNAPLs encountered at contaminated properties are often complex mixtures of these and other chemical compounds.

Remediation of DNAPL in fractured bedrock environments poses particular difficulties compared with porous media such as sand and gravel. For example, delineating DNAPL source areas in fractured bedrock settings is more difficult than in porous media due to the depth of DNAPL penetration. The depth may exceed more than 100 feet below the ground surface because DNAPLs can sink below the water table. Consequently, associated drilling costs may be excessive. Furthermore, in relatively homogenous porous media a “clean” water sample provides evidence there is no DNAPL in the area near the sample. In contrast, “clean” water detected in a sample from a fractured bedrock site provides information only on those fractures that are in hydraulic contact with the well. Remediation of contaminated fractured bedrock is also more difficult compared with porous media due to the difficulties in accessing and attaining hydraulic control of the entire DNAPL source area. For example, in a typical porous medium a line of wells on one side of a DNAPL source area and another line of wells on the other side is sufficient to provide flow through and hydraulic control of the entire DNAPL source area. However, it is not as simple to ensure that all fractures in a given volume of fractured bedrock will be swept effectively because complete connection among fractures may not occur. In fact, many fractures are dead-ended and can provide natural traps for DNAPLs that are not readily accessible by conventional remediation technologies. Finally, poor connectivity of fractures and the common lack of an impermeable “bottom” in some fractured bedrock environments renders attaining hydraulic containment more difficult. This may increase the risks of mobilizing DNAPL into previously unaffected areas.

The use of biodegradation can both enhance the dissolution of DNAPL chemicals into groundwater and destroy the DNAPL chemicals once dissolved. This can occur by means of biologically-mediated reactions until all of the DNAPL has disappeared. However, complete bioremediation of DNAPL source zones requires the presence of appropriate quantities of microorganisms, electron donors, electron acceptors and nutrients. Once dissolved into groundwater the DNAPL chemicals may be directly degraded to innocuous byproducts if microorganisms existing in the groundwater can obtain a sufficient supply of organic carbon, electron donors, electron acceptors and nutrients. Biodegradation also requires appropriate pH and temperature conditions. The dissolved chlorinated compounds can be biodegraded in situ in groundwater to innocuous byproducts when used by microorganisms as sources of organic carbon, electron donors or electron acceptors. In addition, the dissolved chlorinated compounds can be biodegraded in-situ in groundwater by means of cometabolic reactions. In cometabolic reactions, the dissolved chlorinated compounds serve no useful role to the microorganisms and are fortuitously destroyed during other metabolic reactions. Furthermore, in cometabolic degradations, the enzymes produced by the degradation of some other carbon source fortuitously induce breakdown of the compound of interest. Biodegradation remediation in prior art is generally not effective in zones containing DNAPLs due, in part, to a lack of sufficient microorganisms.

All biodegradation reactions depend upon the existence of the appropriate microorganisms to degrade the chemical compounds of interest. These reactions involve either oxidation or reduction of the contaminant and require the presence of an oxidizer (electron acceptor) and a reducer (electron donor). The electron donor and acceptor compounds are known as primary substrates. Many organic compounds are used by microorganisms as primary substrates. Oxygen is a common electron acceptor and in the absence of oxygen so are nitrate, sulfate, iron and carbon dioxide. In addition, the cometabolic degradation of chlorinated compounds is possible under aerobic and anaerobic conditions. These reactions require transfer of electrons, access to nutrients and removal of by-products.

What is needed for adequate biodegradation of chlorinated compounds in DNAPL source sources is a method of enhancing microorganism growth to aid in the in-situ treatment of chemical compounds present within DNAPL zones.

### SUMMARY OF THE INVENTION

It is an aspect of the present invention to use acetic acid to enhance the growth of groundwater microorganisms in DNAPL source zones, increase the dissolution of DNAPL into groundwater and facilitate the in-situ destruction of DNAPL chemicals in groundwater.

It is another aspect of the present invention to use acetic acid to feed microorganisms and create or enhance anaerobic conditions to accomplish in-situ bioremediation of NAPL and DNAPL chemicals in the source areas.

To accomplish these and other aspects of the invention there is a method of in-situ bioremediation for treating underground nonaqueous phase liquid contamination. This includes providing a delivery means for supplying acetic acid to a DNAPL target zone. The next step includes supplying the acetic acid by the delivery means so that the acetic acid is introduced into the DNAPL target zone. This allows the natural microorganisms in the DNAPL target zone to metabolize the acetic acid thereby creating anaerobic conditions and destroying DNAPL chemicals. The final step includes maintaining the anaerobic conditions for a sufficient period of time such that the microorganisms are enhanced and produced until remediation is complete.

These and other aspects of the present invention will become apparent from the following description, the description being used to illustrate the preferred embodiment of the invention when read in conjunction with the accompanying drawings.

### BRIEF DESCRIPTION OF THE DRAWINGS

FIG. 1 is a schematic illustrating the preferred embodiment of the present invention.

FIG. 2 is a cross-sectional view of the preferred embodiment of the invention.

FIG. 3 is a plot showing in-situ the change in biomass of groundwater microorganisms at test sites using the preferred embodiment of the invention.

FIG. 4 is a plot showing the adaptation of groundwater microorganism at test sites using the preferred embodiment of the invention.

FIGS. 5A & 5B are illustrations showing concentrations of chlorinated solvents in groundwater samples at test sites using the preferred embodiment of the invention.

FIGS. 6A & 6B are illustrations showing enhanced dissolution of DNAPL at test sites using the preferred embodiment of the invention.

### DETAILED DESCRIPTION OF THE INVENTION

While the present invention is described with reference to treating subsurface zones containing (DNAPL), a practitioner in the art will recognize the principles of the present invention are applicable elsewhere such as treating subsurface zones with some light nonaqueous phase liquids (LNAPLs) and other contaminants.

The distribution of DNAPL in the subsurface is typically highly irregular making characterization and remediation difficult. In the zone above the water table (sometimes referred to as the “vadose zone”), DNAPL can flow downward toward the water table with relatively little spreading. A small quantity of the DNAPL that is not mobile under static conditions during vadoze zone transport can be retained by capillary forces within each pore space (or bedrock fracture). This remaining immobile DNAPL is sometimes referred to as “residual” DNAPL. However, below the water table the entry of DNAPL into water-filled bedrock fractures requires overcoming an entry pressure resulting from interfacial tension between DNAPL and water. The required entry pressure increases with decreasing fracture aperture (or grain size in porous media). Consequently, DNAPL can flow laterally above fine grained layers accumulating (pooling) until there is sufficient thickness of DNAPL to overcome the entry pressure. Even very subtle variations in fracture aperture or grain size distribution may produce significant deflection of DNAPL flow that results in horizontal lenses, or pools, of DNAPL connected by narrow vertical pathways. Thus, DNAPL can be found as multiple horizontal lenses connected by vertical pathways with one or more pools above fine-grained layers.

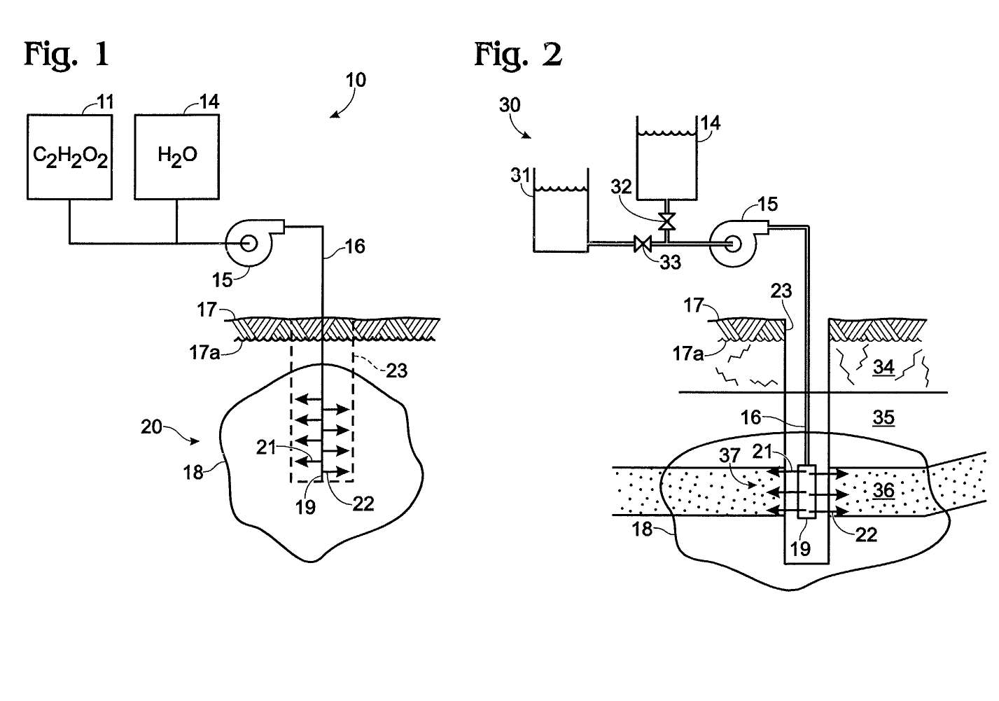

When DNAPL contamination is found, there is a delivery means that includes at least one injection well 23 that is located near the underground DNAPL contamination to permit the addition of acetic acid to augment in-situ growth of microorganisms as shown by method 10 in FIG. 1. Other nutrients that may be required to supplement the acetic acid to augment in-situ growth of microorganisms can be added as well. The steps of method 10 include providing an injection well 23 that extends from the ground surface 17, through and below the groundwater 17a, to a contaminated area 18. The next step is to supply acetic acid 11 with an optional step of supplying fresh water 14 to the injection well 23 by using a pump 15 that is in fluid communication 16 with a screened interval 19. Alternately, supplying the acetic acid and optional fresh water could also be accomplished manually by pouring predetermined doses into the top of the injection well 23. The acetic acid 11 and optional fresh water 14 mixture are introduced into the contaminated area 18 through the screened interval 19. The screen interval 19 allows the mixture to be dispersed into an up-gradient flow 21 (opposite the direction 20 of the groundwater flow) and into a down-gradient flow 22 (the direction 20 of the groundwater flow). This allows microorganisms that are either naturally occurring or introduced within the contaminated area 18 to metabolize the acetic acid 11 for adaptation (enhancement) and increasing their biomass (produced). This metabolization creates or enhances the anaerobic conditions in the contaminated area 18. As is known by the practitioner in the art the mixture composition by weight of acetic acid 11 and fresh water 14 is based upon the contaminated area 18 contaminant and hydrologic and geochemical conditions. For example, in one geochemical condition located in a fractured bedrock environment for the microorganisms to destroy DNAPL chemicals it is necessary to first introduce acetic acid 11 and after a period of time flush with fresh water 14. In other geochemical conditions fresh water may not be required. The final step is to maintain the anaerobic conditions for a sufficient period of time such that the microorganisms are enhanced and produced in the contaminated area 18 until remediation is complete.

The method 10 is put into operation through the use of pump 15 in fluid communication 16 with the screened interval 19 placed inside the injection well 23. Alternately, method 10 could be put into operation by manually injecting the acetic acid 11 and optional fresh water 14 in fluid communication 16 with the screen interval 19 placed inside the injection well 23. The screen interval 19 is placed in the injection well 23 into a contaminated area 18 below the ground surface 17 and water table 17a. The pump 15 is typically a metering pump but is substitutable for a variety of pump types, such as reciprocating, centrifugal and the like, depending on the size and type of application. The pump 15 is operated to force the desired mixture of acetic acid 11 and fresh water 14 through the screened interval 19 into the contaminated area 18. The pump 15 force overcomes the entry pressure of the water-filled bedrock fractures in the contaminated area 18. Alternately, the acetic acid 11 and fresh water 14 can be separately mixed in the injection well 23 and forced into the water-filled bedrock fractures of the contaminated area 18. This is accomplished by providing separate fluid communication 16 of the acetic acid 11 and the fresh water 14 to the screen interval 19. As is known by the practitioner in the art injection well 23 varies in number depending on the amount of contamination in the contaminated area 18 and geological conditions. For example, a typical site contaminated with DNAPLs can have two, three, four or more injection wells. It is also possible that the acetic acid could be injected into the DNAPL source area via trenches, ground surface applications and other drilling methods.

Most practitioners in the art understand that there are many delivery means (methods) that can be used to deliver acetic acid 11 into underground DNAPL source zones. In the preferred embodiment of this invention acetic acid is delivered through specially designed vertical injection well(s) 23 under pressure. However, acetic acid 11 can be delivered to the DNAPL source zone by gravity drainage. The gravity drainage delivery of acetic acid by the way of surface applications includes, but is not limited to, open trenches, pits, ponds and specially designed infiltration galleries. Alternately, other delivery methods of acetic acid 11 to the DNAPL contaminated area 18 be performed during actual drilling operations or through specially designed horizontal injections wells.

In one example, acetic can be delivered to an underground DNAPL zone via gravity drainage from an open pit or trench or a series of pits or trenches. In this case a shallow pit or trench is dug at a selected location and a predetermined dose of acetic acid is placed in the pit or trench and allowed to percolate through soils down to the DNAPL zone. Optionally, dosages of fresh water and supplemental nutrients or microorganisms can be added along with the acetic acid. The dosing requirements are based on DNAPL type and quantity as well as hydrogeologic and geomicrobiologic characteristics. The specifications of the pit or trench including length, width, depth and construction materials are determined on a site-specific basis. This depends on the depth of the DNAPL zone below the ground surface, size and quantity of the DNAPL zone, hydrogeologic and geomicrobiologic characteristics of the site.

In a second example, acetic acid can be delivered to an underground DNAPL zone through a specially designed infiltration gallery or several infiltration galleries. The infiltration gallery consists of an array of horizontal slotted pipes installed within an open excavation. The array of horizontal slotted pipes is connected to a manifold extending above the ground and the excavation is filled with clean soil, gravel or the like. Doses of acetic acid and supplemental materials are then injected into the buried array of horizontal pipes via the manifold and allowed to gravity drain through the soils into the DNAPL zone. The specifications of the infiltration gallery including the number and lengths of pie, slot width, depth and construction materials are determined on a site-specific basis. This depends on the depth of the DNAPL zone below the ground surface, size and quantity of the DNAPL zone, hydrogeologic and geomicrobiologic characteristics of the site.

Acetic acid can be delivered into subsurface DNAPL zones during drilling activities using hollow-stem auger drilling methods, direct-push drilling methods and the like. In these methods, the acetic acid can be delivered to the subsurface DNAPL zone through the drill string by means of pouring those doses of acetic acid (and supplements) through the top of the drill string. The acetic acid is then allowed to drain out of the bottom of the drill string by gravity. The acetic acid will drain out the bottom of the drill string because acetic acid is denser than water at certain concentrations. Alternately, the acetic acid (and supplements) could be forced out of the bottom of the drill string with a pump.

Another delivery method of acetic acid into subsurface DNAPL zones is through horizontally drilled wells. This method is similar to injection through vertically drilled wells. However, a horizontally drilled well or wells have the advantage of being able to influence a larger zone compared with a vertically drilled well or wells.

FIG. 2 illustrates a cross-sectional view of apparatus 30 that is the preferred embodiment of the invention. A pump 15, a mixing tank 31 and a fresh water supply 14 are in fluid communication 16 with a screened interval 19 located in an injection well 23. The injection well 23 is located at a geological site from the ground surface 17, through groundwater 17a, through a layer of fracture basalt 34, through a layer of gray basalt 35 and into a red-brown sandstone 36. As is known by the practitioner in the art the site geological characteristics may vary depending on the location of the contaminated area 18. Nevertheless, the fluid communication 16 typically includes pipe or tubing, a first valve 32 to isolate the fresh water supply 14 from pump 15 and a second valve 33 to isolate the mixing tank 31 from the pump 15. The pump 15 forces the mixture of acetic acid and water contained in the mixing tank 31 into the injection well 23 through the screened interval 19. This is accomplished by opening the second valve 33 and closing the first valve 32. A fresh water supply 14, also in fluid communication 16 with the screened interval 19, is forced by pump 15 into injection well 23 for washing the contaminated area 18 as appropriate. This is accomplished by opening the first valve 32 and closing the second valve 33. Alternately, the mixing tank 31 may only contain acetic acid to be forced into the contaminated area 18 through the screened interval 19 with the use of fresh water 14 to wash the contaminated area 18 as appropriate. Finally, the screened interval 19 is positioned in the injection well 23 below the water table of the groundwater 17a in the contaminated area 18.

The mixture of acetic acid and fresh water is supplied under pressure from pump 15 to a manifold 37 such that the mixture passes though a screened interval 19. The screened interval allows the acetic acid and fresh water to flow in a radial direction from the injection well 23 providing an up-gradient flow 21 and a down-gradient flow 22 for adequate dispersion. The manifold 37 allows complete feeding of the microorganisms in the contaminated area 18 creating improved geomicrobiologic conditions conducive for biodegradation of chlorinated DNAPL chemicals. Alternately, the mixture of acetic acid and water is substitutable for just acetic acid that is first forced through the screened interval 19 later followed by fresh water 14 flushing as appropriate. As is know by the practitioner in the art the screened interval 19 are typically wire or PVC mesh screens to distribute the acetic acid and fresh water. Alternately, the screens are substitutable for other permeable sections that allow adequate distribution of the acetic acid and fresh water.

The indigenous or introduced microorganisms digest the acetic acid utilizing the available dissolved oxygen and other electron acceptors within the contaminated area 18 to produce carbon dioxide and water thereby forming anaerobic conditions within the contaminated area 18. The groundwater microorganisms are enhanced thereby increasing the biomass of the microorganisms that are eventually catalysts in the destruction of DNAPL chemicals to carbon dioxide, water and chloride ions within the contaminated area 18.

To enhance or initiate the in-situ microbial degradation of DNAPL chemicals and maintain activity for extended periods of time in the subsurface contaminated area 18, acetic acid is directly introduced into the contaminated area 18. The acetic acid is injected into the appropriate contaminated area 18 at or below the locus of the contamination. Alternately, the acetic acid can be pooled on the surface and permitted to percolate down to the contaminated area 18. The acetic acid will form noncontiguous pockets of acetic acid that have larger surface areas of contact with the water phase.

If the particular DNAPL chemicals cannot be adequately biodegraded by the native microorganisms when acetic acid is introduced, then exogenous (stimulus) microorganisms can also be introduced into the DNAPL source zone along with the acetic acid. The stimulus microorganisms that are capable of producing anaerobic conditions and degradation of DNAPL chemicals in the contaminated area 18 can be added to the acetic acid prior to injection into the injection well 23. As is known by the practitioner in the art the stimulus microorganisms include, but are not limited to, fungi, enzymes, bacteria and other organisms capable of acting as a catalyst in the destruction of DNAPL chemicals. Furthermore, other materials to enhance the viability and metabolism of the microorganisms can be added to the acetic acid. These other materials include, but are not limited to, nutrients, electron donors, carbon sources and electron acceptors.

As illustrated in FIG. 2, an injection well 23 is connected to a source of acetic acid in tank 31, which is pumped through pump 15 through the well (or bore) to the uppermost portion of the contaminated area 18. In this embodiment an acetic acid mixture is chosen that is more dense than water so that the acetic acid sinks through the groundwater and contaminated area 18. The injection of acetic acid occurs under sufficient pressure to form an up-gradient flow 21 and down-gradient flow 22 that completely surrounds the contaminated area 18 The sinking acetic acid, being an organic liquid, will flow preferentially through the same bedrock fracture channels as contain the DNAPL.

The in-situ microbial degradation of DNAPL chemicals in the contaminated area 18 is initiated and maintained by injecting a mixture of acetic acid and water from tank 31, that is more dense than water, through injection well 23 and the screened interval 19. After the acetic acid injection is stopped the acetic acid will continue to redistribute forming noncontiguous pockets of acetic acid that have a large total surface area of contact with the groundwater within the fractured bedrock.

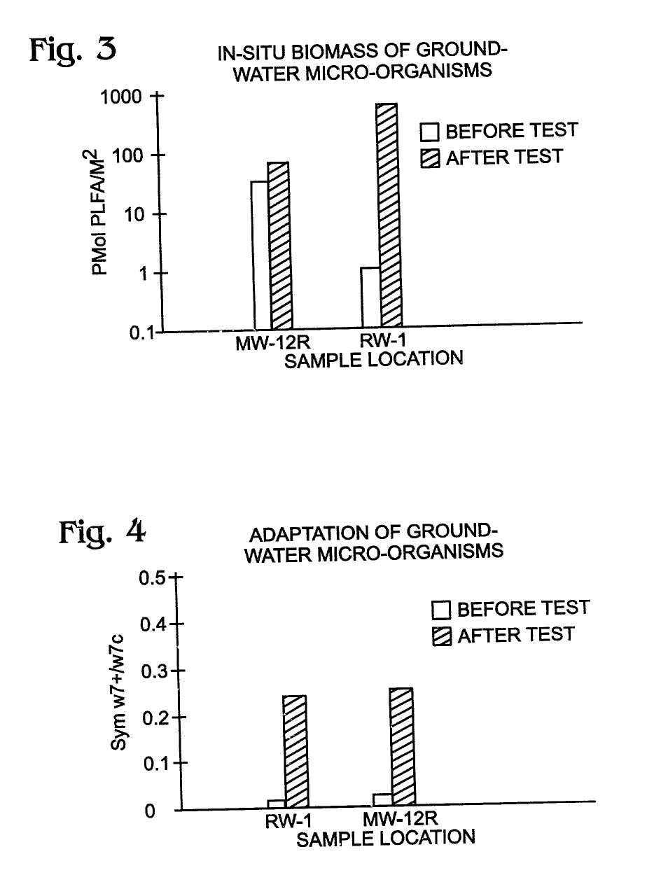

FIGS. 3 and 4 show increased microorganism biomass (production) and adaptation (enhancement) at two DNAPL test sites before and after injection of acetic acid into an injection well. The test sites are located at a property where fractured bedrock has been contaminated with PCE and TCE DNAPL to a depth of approximately 120 feet below ground surface. As shown in FIG. 3, the biomass increased at both test sites after the injection of acetic acid into the DNAPL contaminated area. FIG. 4 shows the adaptation of groundwater microorganisms increased at both test sites after injection of acetic acid into the DNAPL zone. Although both test sites showed increases in microorganism biomass, as plotted in FIG. 3, the sample taken at location RW-1 showed a significantly greater increase in microorganism biomass as compared to the sample taken at location MW-12R.

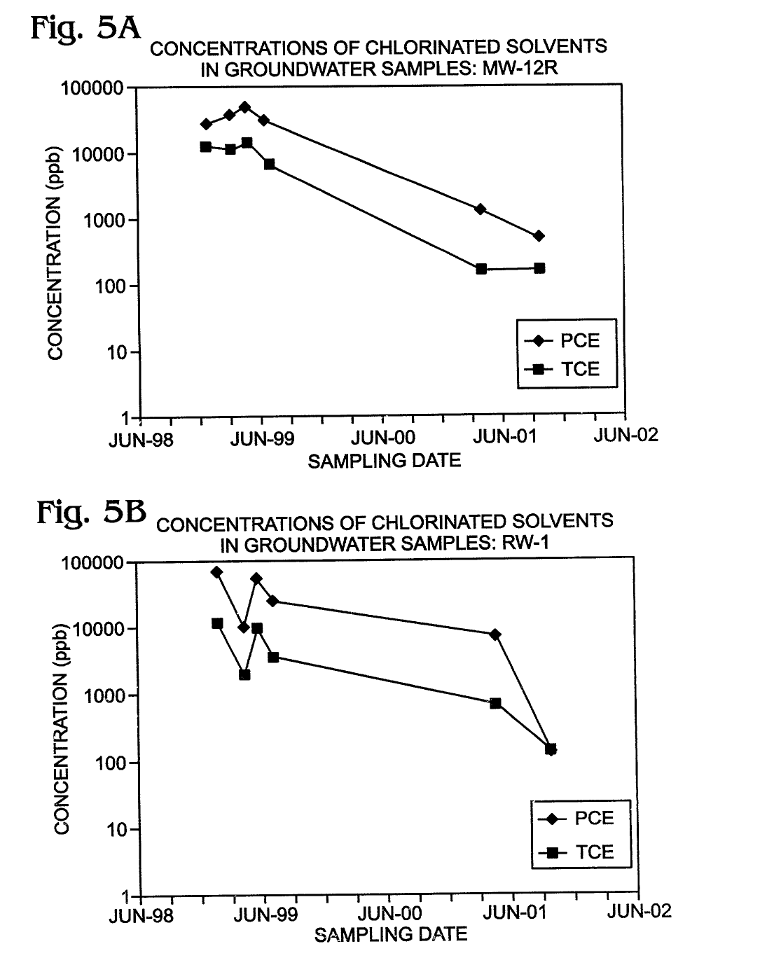

In FIGS. 5A and 5B concentrations of chlorinated solvents in groundwater samples are plotted over a period of time for the same two test sites illustrated in FIGS. 3 and 4. In January 1999, acetic acid was added at a bedrock injection well upgradient from MW-12R and RW-1 and allowed to disperse through the fractured bedrock target zone. As shown, over approximately a 30 month time span the concentrations of PCE and TCE in groundwater were reduced significantly. For example, at test site MW-12R before acetic acid was injected the concentration of PCE in groundwater was about 31,000 parts per billion and the concentration of TCE was about 14,000 parts per billion. These concentrations are consistent with the presence of DNAPL. After acetic acid was introduced at the upgradient bedrock injection well and dispersed throughout the target zone, over a period of about 30 months the concentration of PCE in groundwater at MW-12R dropped to about 520 parts per billion. The concentration of TCE dropped below the detection limit of the analytical instrument which was about 160 parts per billion. The concentrations of chlorinated solvents in groundwater at RW-1, which was also located in the fractured bedrock target zone showed similar trends.

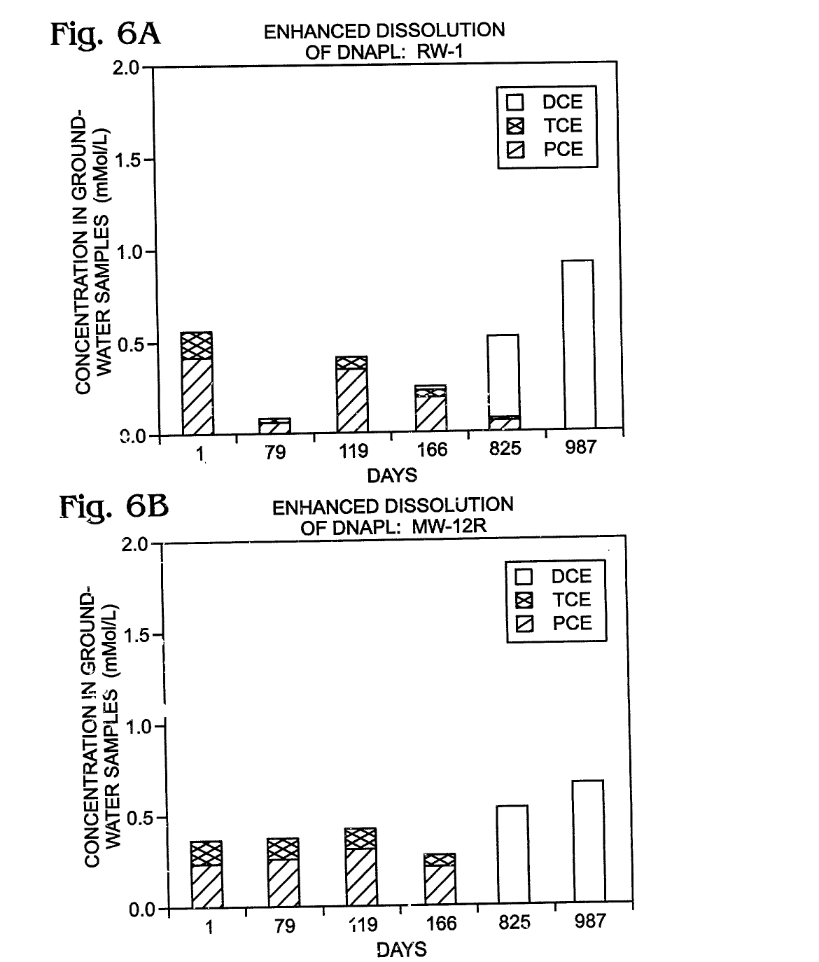

FIGS. 6A and 6B illustrate the enhanced dissolution of the PCE and TCE DNAPL by plotting molar concentrations observed over a period of time during the same acetic acid injection test as illustrated in FIGS. 3, 4, 5A and 5B. At day one acetic acid was added to a bedrock injection well upgradient from MW-12R and RW-1 and allowed to disperse throughout the fractured bedrock target zone. As shown, over a period of about 987 days there was a significant drop in PCE and TCE concentrations in groundwater samples and a greater increase in DCE concentration. For example, at monitor test site well MW-12R before the acetic acid was injected the total chlorinated solvent concentration was about 0.30 mMol/L (PCE concentration was 0.20 mMol/L and TCE concentration was 0.10 mMol/L). DCE was not detected in groundwater samples collected prior to injection of acetic acid. After a period of time, of about 825 days after acetic acid was introduced at the upgradient injection well, the total chlorinated solvent concentration increased to about 0.55 mMol/L and consisted almost entirely of DCE. DNAPL dissolution was enhanced as a result of the acetic acid injection and associated increase in biodegradation. This was demonstrated by the total solvent concentration increasing from 0.30 mMol/L to 0.55 mMol/L coupled with the conversion of PCE and TCE to DCE. Similar trends were observed at monitor test site well RW-1 as shown in FIG. 6B.

The method 10, as shown in FIG. 1, enhances microorganism generation at contaminated sites that contain DNAPLs. The acetic acid 11 and fresh water 14 are injected into a contaminated area 18 by using a screened interval 19 positioned in an injection well 23. The amount by weight of acetic acid 11 mixed with water 11 depends on the contaminant type, amount of DNAPL, geochemical conditions and hydrogeologic conditions. The geological mechanism and apparatus 30, as shown in FIG. 2, to introduce acetic acid into the contaminated area 18 for microorganism growth is the same as previously described for DNAPL chemicals.

While there has been illustrated and described what is at present considered to be the preferred embodiment of the invention, it should be appreciated that numerous change and modifications are likely to occur to those skilled in the art. It is intended in the appended claims to cover all those changes and modifications that fall within the spirit and scope of the present invention.

What is claimed is:

1. A method of in-situ microorganism generation for treatment of underground DNAPL contamination comprising the steps of:
a) providing a delivery means for supplying acetic acid to a DNAPL target zone;
b) supplying said acetic acid by said delivery means whereby said acetic acid is introduced into said DNAPL target zone whereby the natural microorganisms in said DNAPL target zone metabolize said acetic acid thereby creating anaerobic conditions and reducing DNAPL chemicals; and
c) maintaining said anaerobic conditions for a sufficient period of time such that the number of said natural microorganisms are enhanced and increased.

2. The method of in-situ microorganism generation for treatment of underground DNAPL contamination as claimed in claim 1, wherein said acetic acid enhances cometabolic degradation of said natural microorganisms that are catalysts of the destruction of said DNAPL chemicals.

3. The method of in-situ microorganism generation for treatment of underground DNAPL contamination as claimed in claim 1, wherein said natural microorganisms are adapted to metabolize said acetic acid for enhanced bioremediation.

4. The method of in-situ microorganism generation for treatment of underground DNAPL contamination as claimed in claim 1, wherein at least a portion of stimulus microorganisms are supplied to said contaminated area.

5. The method of in-situ microorganism generation for treatment of underground DNAPL contamination as claimed in claim 1, wherein said delivery means supplying said acetic acid further includes at least one injection well extending from the ground surface, through and below the ground water to said DNAPL target zone

6. The method of in-situ microorganism generation for treatment of underground DNAPL contamination as claimed in claim 5, wherein the steps of supplying said acetic acid comprises:
placing a pump in fluid communication with said at least one injection well; and
operating said pump to force said acetic acid into said contamination area.

7. The method of in-situ microorganism generation for treatment of underground DNAPL contamination as claimed in claim 1, further comprising the step of mixing said acetic acid and fresh water in said injection well.

8. The method of in-situ microorganism generation for treatment of underground DNAPL contamination as claimed in claim 1, further comprising the step of injecting said acetic acid into said contaminated area and then flushing said contaminated area with fresh water.

9. The method of in-situ microorganism generation for treatment of underground DNAPL contamination as claimed in claim 5, further comprising:
placing a manifold within said at least one injection well, said manifold having a screened-interval section below the water table of said contaminated area;
wherein said acetic acid passes through said screened-interval section into said contaminated area.

10. The method of in-situ microorganism generation for treatment of underground DNAPL contamination as claimed in claim 5, wherein said acetic acid is supplied under pressure to said manifold, such that said acetic acid passes through said screened-interval section, thereby flowing in a radial direction from said at least one injection well feeding the natural microorganisms in the contaminated area creating improved geomicrobiologic conditions.

11. The method of in-situ microorganism generation for treatment of underground DNAPL contamination as claimed in claim 1, wherein said contamination further includes all forms of nonaqueous phase liquids

12. The method of in-situ microorganism generation for treatment of underground DNAPL contamination as claimed in claim 5, wherein said acetic acid is injected into said injection well in its natural state.

13. The method of in-situ microorganism generation for treatment of underground DNAPL contamination as claimed in claim 1, wherein said acetic acid is further combined with stimulus microorganisms to enhance natural microorganism growth and biodegradation.

14. The method of in-situ microorganism generation for treatment of underground DNAPL contamination as claimed in claim 13, wherein said stimulus microorganisms are a variety of anaerobic microbes.

15. The method of in-situ microorganism generation for treatment of underground DNAPL contamination as claimed in claim 1, wherein said acetic acid is introduced into said contaminated area whereby the microorganisms in said contaminated area metabolize said acetic acid enhancing anaerobic conditions and destroy DNAPL chemicals.

16. The method of in-situ microorganism generation for treatment of underground DNAPL contamination as claimed in claim 1, wherein said delivery means is a plurality of methods.
